(19) United States
(12) Patent Application Publication
(10) Pub. No.: US 2015/0166903 A1
(43) Pub. Date: Jun. 18, 2015

(54) PROCESS FOR PRODUCING VARIOUS VISCOSITY GRADES OF BITUMEN

(71) Applicant: INDIAN OIL CORPORATION LIMITED, Mumbai, Maharashtra (IN)

(72) Inventors: Naduhatty Selai Raman, Faridabad (IN); Palvannan Mohanasundaram, Faridabad (IN); Irudayaraj Devotta, Faridabad (IN); Kishan Chand Sharma, Faridabad (IN); Vivekanand Kagdiyal, Faridabad (IN); Deepak Saxena, Faridabad (IN); Brijesh Kumar, Faridabad (IN); Anurag Ateet Gupta, Faridabad (IN); Santanam Rajagopal, Faridabad (IN); Ravinder Kumar Malhotra, Faridabad (IN)

(21) Appl. No.: 14/414,408

(22) PCT Filed: Jul. 12, 2013
(86) PCT No.: PCT/IB2013/055736

§ 371 Date: Jan. 12, 2015

(30) Foreign Application Priority Data
Jul. 14, 2012 (IN) 2039/MUM/2012

(51) Int. Cl. C10G 53/04; C08L 95/00

(52) U.S. Cl. CPC C10G 53/04; C08L 95/00; C08L 2555/74

(57) ABSTRACT

The present invention relates to an aromatic enriched deasphalted oil extract fraction for preparing bitumen. The present invention also relates to a process for preparing the aromatic enriched deasphalted oil extract fraction for preparing bitumen. The present invention further relates to bitumen and process for preparing the bitumen using the aromatic enriched deasphalted oil extract fraction. The aromatic enriched deasphalted oil extract fraction obtained in accordance with the present invention can be used preparing plurality of grades of bitumen. Also, bitumen obtained in accordance with the present invention contains extremely low concentration of poly cyclic aromatics and more particularly benzo(a)pyrene.

### FIELD OF THE INVENTION

The present invention relates to an aromatic enriched deasphalted oil extract fraction for preparing bitumen. The present invention also relates to a process for preparing the aromatic enriched deasphalted oil extract fraction for preparing bitumen. The present invention further relates to bitumen and process for preparing the bitumen using the aromatic enriched deasphalted oil extract fraction. The aromatic enriched deasphalted oil extract fraction obtained in accordance with the present invention can be used preparing plurality of grades of bitumen. Also, bitumen obtained in accordance with the present invention contains extremely low concentration of poly cyclic aromatics and more particularly benzo(a)pyrene.

### BACKGROUND OF THE INVENTION

As is conventionally known, for production of bitumen, primary asphalt obtained from deasphalting process is blended with aromatic extract obtained from an extraction process. However, bitumen thus obtained has been observed to contain high concentration of poly cyclic aromatics (PCA), which are now categorized as carcinogenic material. In addition to the concentration of PCA, which is required to be low, it is also preferred that the bitumen thus obtained has to be substantially free of benzo(a)pyrene. Even if present, benzo(a)pyrene is to be present at concentration of less than 1 ppm.

In addition, it is well known that bitumen is classified into various grades depending on application. While the aforesaid requirements relating to the concentration of PCA and benzo(a)pyrene being very low, the bitumen should be such that it can be utilized effectively for the desired end application. In this regard, it is well known that bitumen is classified into the at least four grades namely Viscosity Grade-10 (VG10) grade bitumen, Viscosity Grade-20 (VG20) grade bitumen, Viscosity Grade-30 (VG30) grade bitumen and Viscosity Grade-40 (VG40) grade bitumen.

By way of example, Viscosity Grade-10 (VG10) grade bitumen is required to have a minimum kinematic viscosity of 250 cSt at 135° C., a minimum absolute viscosity of 800 poise at 60° C., a penetration point ranging from 80 to 100 ( 1/10 mm) at 25° C. and a minimum softening point of 40° C. Viscosity Grade-20 (VG20) grade bitumen is required to have a minimum kinematic viscosity of 300 cSt at 135° C., a minimum absolute viscosity of 1600 poise at 60° C., a penetration point ranging from 60 to 80 ( 1/10 mm) at 25° C. and a minimum softening point of 45° C. On the other hand Viscosity Grade-30 (VG30) grade bitumen is required to have a minimum kinematic viscosity of 350 cSt at 135 ° C., a minimum absolute viscosity of 2400 poise at 60° C., a penetration point range from 50 to 70 ( 1/10 mm) at 25° C. and a minimum softening point of 47° C. Lastly, Viscosity Grade-40 (VG40) grade bitumen is required to have a minimum kinematic viscosity of 400 cSt at 135° C., a minimum absolute viscosity of 3200 poise at 60° C., a penetration point range from 40 to 60 ( 1/10 mm) at 25° C. and a minimum softening point of 50° C. Further details of the various Thus, it can be clearly observed that the aforesaid plurality of grades of bitumen have diverse properties.

Presently, the industry practice for producing the aforesaid different grades of bitumen is to blend primary asphalt obtained from deasphalting process is blended with aromatic extracts having different boiling ranges. More particularly, aromatic extract obtained from Inter neutral as the feed is used for preparing a first grade of bitumen, while aromatic extract obtained from Heavy neutral as the feed is used for preparing a second grade of bitumen and aromatic extract obtained from Bright neutral as the feed is used for preparing a third grade of bitumen, and so on.

By way of example, U.S. Pat. No. 5,308,470 claims non-carcinogenic asphalt blending stock with mutagenic index less than 1.0 which is limited to mutagenic index and its relationship with physical property (boiling point).

U.S. Pat. No. 5,961,709 discloses an environmentally improved asphalt paving composition which contains a solvent precipitated asphaltene and paraffinic fluxing component. However it does not disclose the process of making various viscosity grades of bitumen using aromatic extract and the amount of PCA in the bitumen.

U.S. Pat. No. 5,403,526 discloses a process for preparing a benzo(a)pyrene free carbon containing refractory ceramic material using bitumen-resin etc. However, this patent does not disclose the various viscosity grades bitumen with low poly cyclic aromatic contents.

Thus, from the above, it can be observed that there is no teaching relating to an aromatic enriched deasphalted oil extract fraction for preparing bitumen, wherein the aromatic enriched deasphalted oil extract fraction in itself comprises very low concentration of PCA, is substantially free of benzo(a)pyrene and is capable of being used to prepare plurality of grades of bitumen. Thus, there is a need to provide improved solutions in this direction.

### OBJECT OF THE INVENTION

Thus, it is an object of the invention to provide an aromatic enriched deasphalted oil extract fraction for preparing bitumen, wherein the aromatic enriched deasphalted oil extract fraction in itself comprises very low concentration of PCA, is substantially free of benzo(a)pyrene and is capable of being used to prepare plurality of grades of bitumen.

Another object of the invention is to provide a process for preparing the aromatic enriched deasphalted oil extract fraction.

Yet another objet of the invention is to provide bitumen of varying grades comprising very low concentration of PCA and substantially free of benzo(a)pyrene.

Still another object of the invention is to provide processes for preparing bitumen of varying grades comprising very low concentration of PCA and substantially free of benzo(a)pyrene.

### DETAILED DESCRIPTION OF THE INVENTION

The present invention provides an aromatic enriched deasphalted oil extract fraction for preparing bitumen, comprising ingredients having a minimum initial boiling point (IBP) of 490° C.; at least 10 wt % of ingredients in the boiling range of IBP to 550° C.; and ingredients contributing to aromatic carbon in the range of 25 to 75 wt %. The aromatic enriched deasphalted oil extract fraction exhibits an aniline point in the range of 55° to 70° C. Also, the aromatic enriched deasphalted oil extract fraction comprises less than 10 ppm of poly cyclic aromatics (PCA) ingredients selected from the group consisting of benzo(a)anthracene+chrysene, benzo(j)floranthene, benzo(e)pyrene, benzo(b)floranthene, benzo(K)floranthene, benzo(a)pyrene and dibenzo(a,h)anthracene; with benzo(a)pyrene concentration of less than 1 ppm.

Not being bounded by any particular theory, it is believed that an aromatic enriched deasphalted oil extract fraction comprising ingredients having a minimum initial boiling point (IBP) of 490° C.; with at least 10 wt % of ingredients in the boiling range of IBP to 550° C.; and ingredients contributing to aromatic carbon being in the range of 25 to 75 wt % contributes to higher solubility of asphalt.

Once again, not being bounded to any particular theory, it is believed that the aromatic enriched deasphalted oil extract fraction of the aforesaid nature exhibits a strong molecular cohesion with regard to asphalt and hence, is therefore better suited for preparing bitumen. One of the problems which is generally faced by the industry while preparing solvent for use in bitumen preparation is that asphalt is a mixture of many compounds with a wide range of solubility parameters. Similarly, the solvents which are used are also a mixture of many compounds with a wide range of solubility parameters. Sometimes, Hildebrand solubility parameter (which describes the total cohesive energy density of the molecule) is taken for a preliminary and crude tool to determine suitability of a particular solvent for use in bitumen preparation, wherein Hildebrand solubility parameter for a molecule is derived from the heat of vaporization of the molecule using the following formula:

Hildebrand solubility parameter (δ)=(▴H-RT)/Vₘ)^{0.5}

wherein ▴H—Heat of vaporization, R—Gas Constant, T-Absolute temperature, Vₘ-Molar volume.

In this regard, while it is not possible to determine the Hildebrand value of the aromatic enriched deasphalted oil extract fraction as a whole, because it tends to comprise many molecules. Once again, without being bounded to any particular theory, it is believed that the aromatic enriched deasphalted oil extract fraction of the aforesaid nature is enriched with ingredients which have Hildebrand solubility value in the range of 18 to 22 and hence, exhibits a strong molecular cohesion with regard to asphalt.

Since, Hildebrand value of the aromatic enriched deasphalted oil extract fraction as a whole is not determinable, without being bounded to any particular theory, it is believed that if aniline point of the aromatic enriched deasphalted oil extract fraction is maintained in the range of 55° to 70° C., the aromatic enriched deasphalted oil extract fraction is enriched with ingredients which have Hildebrand solubility value in the range of 18 to 22.

However, it should be noted that an extract possessing only one characteristic, for example merely having aniline point alone in the range of 55° to 70° C. is not sufficient or in other words may not provide the desired results. Thus, the extract must possess substantially all of the remaining characteristics.

The present invention provides a process for preparing an aromatic enriched deasphalted oil extract fraction for use in preparing bitumen, comprising:
(a) subjecting a reduced crude oil to a distillation process to obtain vacuum residue comprising ingredients having a minimum initial boiling point (IBP) of 490° C. and at least 10 wt % of ingredients in the boiling range of IBP to 550° C.;
(b) subjecting the vacuum residue thus obtained to a de-asphalting process to obtain de-asphalted oil and asphalt;
(c) separating the asphalt thus produced; and
(d) subjecting the de-asphalted oil to aromatic extraction process to obtain the aromatic enriched deasphalted oil extract fraction comprising ingredients having a minimum initial boiling point (IBP) of 490° C.; at least 10 wt % of ingredients in the boiling range of IBP to 550° C.; and ingredients contributing to aromatic carbon in the range of 25 to 75 wt %; the aromatic enriched deasphalted oil extract fraction exhibiting an aniline point in the range of 55° to 70° C.; and comprises less than 10 ppm of poly cyclic aromatics (PCA) ingredients selected from the group consisting of benzo(a)anthracene+chrysene, benzo(j)floranthene, benzo(e)pyrene, benzo(b)floranthene, benzo(K)floranthene, benzo(a)pyrene and dibenzo(a,h)anthracene; with benzo(a)pyrene concentration of less than 1 ppm.

In an embodiment of the present invention, the reduced crude oil is selected from the group comprising of Arab mix, Basrah Light, Kuwait, etc.

By way of a non-limiting example, the reduced crude oil has the following characteristics:

| | |
|---|---|
| Density | 0.9489 |
| Distillation data (D1160) ° C. | |
| IBP | 277 |
| 5 vol % | 325 |
| 10 vol % | 349 |
| 20 vol % | 389 |
| 30 vol % | 432 |
| 40 vol % | 478 |
| 50 vol % | 521 |
| 60 vol % | 561 |

In an embodiment of the present invention, wherein subjecting the reduced crude oil to distillation comprises performing a distillation process in accordance with any of ASTM standard procedure number D1160 or D5236.

In an embodiment of the present invention, subjecting the vacuum residue thus obtained to a de-asphalting process comprises a solvent based deasphalting process comprising the step of contacting the vacuum reside with C3-C6 alkanes and its isomers and mixture. Particularly, the de-asphalting process comprises contacting the vacuum reside with a source of propane in a column reactor having top and bottom temperatures of about 65° C. and about 55° C., respectively to obtain de-asphalted oil (DAO) and asphalt, wherein about eight parts by volume of propane is contacted with one part by volume of the vacuum reside.

In another embodiment of the present invention the vacuum residue can be subjected to a de-asphalting process as described for instance in any of WIPO publication No. WO2013064954, U.S. Pat. No. 4,502,944, U.S. Pat. No. 4,747,936, U.S. Pat. No. 4,191,639, U.S. Pat. No. 3,975,396, U.S. Pat. No. 3,627,675, U.S. Pat. No. 2,729,589.

In another embodiment of the present invention, subjecting the deasphalted oil to extraction process comprises:
(a) contacting the deasphalted oil with a solvent system and producing an extract phase and a raffinate product phase; and
(b) separating the extract phase from the raffinate product phase; wherein:
(c) the solvent system comprises a primary solvent and a co-solvent capable of facilitating phase separation, wherein the primary solvent comprises N-methyl pyrolidone (NMP) or furfural and the co-solvent comprises one or more aliphatic amides having carbon chain of less than 5 carbon atoms, wherein the co-solvent is preferably selected from formamide, n-methyl formamide and n-n dimethyl formamide and wherein a ratio of primary solvent to the co-solvent is in the range of 70:30 to 95:5.

In another embodiment of the present invention, the deasphalted oil can be subjected to an extraction process as described for instance in U.S. Pat. No. 3,929,617.

The present invention provides bitumen, comprising primary asphalt and 1 to 40 wt % of aromatic enriched deasphalted oil extract fraction, wherein the aromatic enriched deasphalted oil extract fraction comprises ingredients having a minimum initial boiling point (IBP) of 490° C.; at least 10 wt % of ingredients in the boiling range of IBP to 550° C.; poly cyclic aromatics (PCA) ingredients selected from the group consisting of benzo(a)anthracene+chrysene, benzo(j)floranthene, benzo(e)pyrene, benzo(b)floranthene, benzo(K)floranthene, benzo(a)pyrene and Dibenzo(a,h)anthracene being present at a concentration of less than 10 ppm; with benzo(a)pyrene concentration of less than 1 ppm; an aniline point in the range of 55° to 70° C. and ingredients contributing to aromatic carbon in the range of 25 to 75 wt %.

In an embodiment of the present invention, the bitumen is Viscosity Grade-10 (VG10) grade bitumen comprising 20 to 40 wt % of aromatic enriched deasphalted oil extract fraction and having a minimum kinematic viscosity of 250 cSt at 135° C., a minimum absolute viscosity of 800 poise at 60° C., a penetration point ranging from 80 to 100 ( 1/10 mm) at 25° C. and a minimum softening point of 40° C.

In an embodiment of the present invention, the bitumen is Viscosity Grade-20 (VG20) grade bitumen comprising 15 to 35 wt % of aromatic enriched deasphalted oil extract fraction and having a minimum kinematic viscosity of 300 cSt at 135° C., a minimum absolute viscosity of 1600 poise at 60° C., a penetration point ranging from 60 to 80 ( 1/10 mm) at 25° C. and a minimum softening point of 45° C.

In an embodiment of the present invention, the bitumen is Viscosity Grade-30 (VG30) grade bitumen comprising 10 to 30 wt % of aromatic enriched deasphalted oil extract fraction and having a minimum kinematic viscosity of 350 cSt at 135 ° C., a minimum absolute viscosity of 2400 poise at 60° C., a penetration point range from 50 to 70 ( 1/10 mm) at 25° C. and a minimum softening point of 47° C.

In an embodiment of the present invention the bitumen is Viscosity Grade-40 (VG40) grade bitumen comprising 5 to 25 wt % of aromatic enriched deasphalted oil extract fraction and having a minimum kinematic viscosity of 400 cSt at 135° C., a minimum absolute viscosity of 3200 poise at 60° C., a penetration point range from 40 to 60 ( 1/10 mm) at 25° C. and a minimum softening point of 50° C.

The present invention provides a process for preparing bitumen, comprising:
(a) subjecting a reduced crude oil to a distillation process to obtain vacuum residue comprising ingredients having a minimum initial boiling point (IBP) of 490° C. and at least 10 wt % of ingredients in the boiling range of IBP to 550° C.;
(b) subjecting the vacuum residue thus obtained to a de-asphalting process to obtain de-asphalted oil and asphalt;
(c) separating the asphalt thus produced;
(d) subjecting the de-asphalted oil to aromatic extraction process to obtain an aromatic enriched deasphalted oil extract fraction comprising ingredients having a minimum initial boiling point (IBP) of 490° C.; at least 10 wt % of ingredients in the boiling range of IBP to 550° C.; poly cyclic aromatics (PCA) ingredients selected from the group consisting of benzo(a)anthracene+chrysene, benzo(j)floranthene, benzo(e)pyrene, benzo(b)floranthene, benzo(K)floranthene, benzo(a)pyrene and Dibenzo(a,h)anthracene being present at a concentration of less than 10 ppm; with benzo(a)pyrene concentration of less than 1 ppm; an aniline point in the range of 55° to 70° C. and ingredients contributing to aromatic carbon in the range of 25 to 75 wt %; and
(e) mixing asphalt with 1 to 40 wt % of the aromatic enriched deasphalted oil extract fraction thus obtained in step (d).

In an embodiment of the present invention, the reduced crude oil is selected from the group comprising of Arab mix, Basrah Light, Kuwait, etc.

In an embodiment of the present invention, wherein subjecting the reduced crude oil to distillation comprises performing a distillation process in accordance with any of ASTM standard procedure number D1160 or D5236.

In an embodiment of the present invention, subjecting the vacuum residue thus obtained to a de-asphalting process comprises a solvent based deasphalting process comprising the step of contacting the vacuum reside with C3-C6 alkanes and its isomers and mixture. Particularly, the de-asphalting process comprises contacting the vacuum reside with a source of propane in a column reactor having top and bottom temperatures of about 65° C. and about 55° C., respectively to obtain de-asphalted oil (DAO) and asphalt, wherein about eight parts by volume of propane is contacted with one part by volume of the vacuum reside.

In another embodiment of the present invention the vacuum residue can be subjected to a de-asphalting process as described for instance in any of WIPO publication No. WO2013064954, U.S. Pat. No. 4,502,944, U.S. Pat. No. 4,747,936, U.S. Pat. No. 4,191,639, U.S. Pat. No. 3,975,396, U.S. Pat. No. 3,627,675, U.S. Pat. No. 2,729,589.

In another embodiment of the present invention, subjecting the deasphalted oil to extraction process comprises:
(d) contacting the deasphalted oil with a solvent system and producing an extract phase and a raffinate product phase; and
(e) separating the extract phase from the raffinate product phase; wherein:
(f) the solvent system comprises a primary solvent and a co-solvent capable of facilitating phase separation, wherein the primary solvent comprises N-methyl pyrolidone or furfural and the co-solvent comprises one or more aliphatic amides having carbon chain of less than 5 carbon atoms, wherein the co-solvent is preferably selected from formamide, n-methyl formamide and n-n dimethyl formamide and wherein a ratio of primary solvent to the co-solvent is in the range of 70:30 to 95:5.

In another embodiment of the present invention, the deasphalted oil can be subjected to an extraction process as described for instance in U.S. Pat. No. 3,929,617.

The present invention will be further specified through the following examples, which are described with only illustrative purpose, and by no means intended to limiting or restricting the scope of the present invention.

### EXAMPLE 1

### VG10 Grade Bitumen

Reduced crude oil is subjected to vacuum distillation process under reduced pressure to obtain vacuum residue. The minimum initial boiling point of resultant vacuum residue is maintained above 500° C. The vacuum residue further is subjected to solvent deasphalting process with the eight parts by volume of propane added to one part by volume of vacuum residue with column top and bottom temperatures of 65° C. and 55° C. to obtain DAO and asphalt. The deasphalted oil from above process is further subjected to aromatic extraction with N-methyl pyrolidone (NMP) solvent in counter current extractor with top and bottom temperature of 90° C. and 80° C. and solvent to oil ratio (volume/volume) being maintained at 2.25 to obtain aromatic enriched deasphalted oil extract fraction. The aromatic enriched deasphalted oil extract fraction obtained from the extraction process is blended with asphalt obtained in deasphalting process, composition of extract being 35wt %, for producing VG10 grade bitumen with extremely low polycyclic aromatic compounds.

TABLE 1
Properties of Viscosity Grade 10 Bitumen derived from blending of DAO
extract with Asphalt

| S. No. | Property | VG10 grade bitumen |
|---|---|---|
| 1 | Penetration ( 1/10 mm) | 88 |
| 2 | Softening point (° C.) | 46 |
| 3 | Kinematic Viscosity @ 135° C.(cSt) | 310 |
| 4 | Poly Cyclic Aromatic content(ppm) | 6 ppm (mass) |
| | Benzo(a)pyrene content (ppm) | 0.6 ppm (mass) |

### EXAMPLE 2

### VG20 Grade Bitumen

Reduced crude oil is subjected to vacuum distillation process under reduced pressure to obtain vacuum residue. The minimum initial boiling point of resultant vacuum residue is maintained above 500° C. The vacuum residue further is subjected to solvent deasphalting process with the eight parts by volume of propane added to one part by volume of vacuum residue with column top and bottom temperatures of 65° C. and 55° C. to obtain DAO and asphalt. The deasphalted oil from above process is further subjected to aromatic extraction with NMP solvent in counter current extractor with top and bottom temperature of 90° C. and 80° C. and solvent to oil ratio (volume/volume) being maintained at 2.25 to obtain aromatic enriched deasphalted oil extract fraction. The aromatic enriched deasphalted oil extract fraction obtained from the extraction process is blended with asphalt obtained in deasphalting process, composition of extract being 30wt %, for producing VG20 grade bitumen with extremely low polycyclic aromatic compounds.

TABLE 2
Properties of Viscosity Grade 20 Bitumen derived from blending of DAO
extract with Asphalt

| S. No. | Property | VG20 Grade bitumen |
|---|---|---|
| 1 | Penetration ( 1/10 mm) | 64 |
| 2 | Softening point (° C.) | 48 |
| 3 | Kinematic Viscosity @ 135° C.(cSt) | 370 |
| 4 | Poly Cyclic Aromatic content(ppm) | 5 ppm |
| | Benzo(a)pyrene content (ppm) | 0.6 ppm |

### EXAMPLE 3

### VG30 Grade Bitumen

Reduced crude oil is subjected to vacuum distillation process under reduced pressure to obtain vacuum residue. The minimum initial boiling point of resultant vacuum residue is maintained above 500° C. The vacuum residue further is subjected to solvent deasphalting process with the eight parts by volume of propane added to one part by volume of vacuum residue with column top and bottom temperatures of 65° C. and 55° C. to obtain DAO and asphalt. The deasphalted oil from above process is further subjected to aromatic extraction with NMP solvent in counter current extractor with top and bottom temperature of 90° C. and 80° C. and solvent to oil ratio (volume/volume) being maintained at 2.25 to obtain aromatic enriched deasphalted oil extract fraction. The aromatic enriched deasphalted oil extract fraction obtained from the extraction process is blended with asphalt obtained in deasphalting process, composition of extract being 25 wt % in the blend for producing VG 30 grade bitumen with extremely low polycyclic aromatic compounds

TABLE 3
Properties of Viscosity Grade 30 Bitumen derived from blending of DAO
extract with Asphalt

| S. No. | Property | VG30 grade bitumen |
|---|---|---|
| 1 | Penetration ( 1/10 mm) | 52 |
| 2 | Softening point (° C.) | 51 |
| 3 | Kinematic Viscosity @ 135° C. (cSt) | 428 |
| 4 | Poly Cyclic Aromatic content(ppm) | 5 ppm |
| | Benzo(a)pyrene content (ppm) | 0.5 ppm |

### EXAMPLE 4

### VG40 Grade Bitumen

Reduced crude oil is subjected to vacuum distillation process under reduced pressure to obtain vacuum residue. The minimum initial boiling point of resultant vacuum residue is maintained above 500° C. The vacuum residue further is subjected to solvent deasphalting process with the eight parts by volume of propane added to one part by volume of vacuum residue with column top and bottom temperatures of 65° C. and 55° C. to obtain DAO and asphalt. The deasphalted oil from above process is further subjected to aromatic extraction with NMP solvent in counter current extractor with top and bottom temperature of 90° C. and 80° C. and solvent to oil ratio (volume/volume) being maintained at 2.25 to obtain aromatic enriched deasphalted oil extract fraction. The aromatic enriched deasphalted oil extract fraction obtained from the extraction process is blended with asphalt obtained in deasphalting process, composition of extract being 20wt % in the blend for producing VG 40 grade bitumen with extremely low polycyclic aromatic compounds.

TABLE 4
Properties of Viscosity Grade 20 Bitumen derived from blending of DAO
extract with Asphalt

| S. No | Property | VG40 grade bitumen |
|---|---|---|
| 1 | Penetration ( 1/10 mm) | 43 |
| 2 | Softening point (° C.) | 52 |
| 3 | Kinematic Viscosity @ 135° C. (cSt) | 494 |
| 4 | Poly Cyclic Aromatic content(ppm) | 4 ppm |
| | Benzo(a)pyrene content (ppm) | 0.3 ppm |

### EXAMPLE 5

### Comparative Example

Reduced crude oil is subjected to vacuum distillation process under reduced pressure to obtain vacuum residue. The minimum initial boiling point of resultant vacuum residue is varied as shown in Table 5. The vacuum residue further is subjected to solvent deasphalting process with the eight parts by volume of propane added to one part by volume of vacuum residue with column top and bottom temperatures of 65° C. and 55° C. to obtain DAO and asphalt. The deasphalted oil from above process is further subjected to aromatic extraction with NMP solvent in counter current extractor with top and bottom temperature of 90° C. and 80° C. and solvent to oil ratio (volume/volume) being maintained at 2.25 to obtain aromatic enriched deasphalted oil extract fractions. These aromatic enriched deasphalted oil extract fractions are evaluated and the outcome is provided in Table 5. Also, some of the aromatic enriched deasphalted oil extract fractions are taken and bitumen is prepared using the same and their properties are also provided in Table 5.

TABLE 5

| | | % of | Aniline | Benzo (a) | | Aromatic | Extract | Peneration | Softening | | |
|---|---|---|---|---|---|---|---|---|---|---|---|
| | | ingredients | Point | Pyrene | PAC | Carbon | Comp | Point, | point | KV | |
| | IBP | in IBP-550 | (° C.) | (ppm) | (ppm) | content | (wt %) | 1/10 mm | (° C.) | (cSt) | Inference |
| EX1 | 490 | Min. 10% | 58 | 0.7 | 4.9 | 31% | | | | | Pass |
| | | | | | | | | | | | (PAH) |
| EX2 | 490 | Min. 10% | 67 | 0.6 | 4.7 | 28.5% | | | | | Pass |
| | | | | | | | | | | | (PAH) |
| EX3 | 430 | Min. 10% | 63 | 7.1 | 47 | 32% | | | | | Fail |
| | | | | | | | | | | | (PAH) |
| Ex5 | 400 | Min. 10% | 57 | 8 | 82 | 34% | | | | | Fail |
| | | | | | | | | | | | (PAH) |
| EX6 | 450 | Min. 10% | 66 | 7 | 35 | 30% | 25% | 99 | 46 | 214 | Fail |
| | | | | | | | | | | | (KV & |
| | | | | | | | | | | | PAH) |
| EX7 | 490 | 5% | 89 | 0.6 | 5 | 19% | 19% | 37 | 54 | 498 | Failed |
| | | | | | | | | | | | (Pen) |
| EX8 | 500 | Min. 10% | 67 | 0.6 | 4.7 | 28% | VG10-25% | 85 | 45 | 310 | Pass |
| | | | | | | | VG20-22% | 64 | 48 | 370 | |
| | | | | | | | VG30-19% | 55 | 49 | 428 | |
| | | | | | | | VG40-17% | 45 | 51 | 494 | |
| EX9 | 500 | 5% | 94 | Less | Less | 18% | — | — | — | — | Failed in |
| | | | | than 1 | than 10 | | | | | | aniline |
| | | | | ppm | ppm | | | | | | Point |
| EX10 | 500 | Min. 10% | 68 | Less | Less | 26% | — | — | — | — | Pass |
| | | | | than 1 | than 10 | | | | | | |
| | | | | ppm | ppm | | | | | | |

It may be noted that the embodiments illustrated and discussed in this specification are intended only to teach to those skilled in the art the best way known to the Inventors to make and use the invention. In describing embodiments of the Invention, specific terminology is employed merely for the sake of clarity. However, the invention is not intended to be restricted to specific terminology so-used. The above-described embodiments of the invention may be modified or varied, without departing from the invention, as appreciated by those skilled in the art in light of the above teachings. It is therefore understood that, within the scope of the claims and their equivalents, the invention may be practiced otherwise than as specifically described.

We claim:

1. An aromatic enriched deasphalted oil extract fraction for preparing bitumen, comprising ingredients having a minimum initial boiling point (IBP) of 490° C.; at least 10 wt % of ingredients in the boiling range of IBP to 550° C.; and ingredients contributing to aromatic carbon in the range of 25 to 75 wt %. The aromatic enriched deasphalted oil extract fraction exhibits an aniline point in the range of 55° to 70° C. Also, the aromatic enriched deasphalted oil extract fraction comprises less than 10 ppm of poly cyclic aromatics (PCA) ingredients selected from the group consisting of benzo(a)anthracene+chrysene, benzo(j)floranthene, benzo(e)pyrene, benzo(b)floranthene, benzo(K)floranthene, benzo(a)pyrene and dibenzo(a,h)anthracene; with benzo(a)pyrene concentration of less than 1 ppm.

2. A process for preparing an aromatic enriched deasphalted oil extract fraction for use in preparing bitumen, comprising:
a. subjecting a reduced crude oil to a distillation process to obtain vacuum residue comprising ingredients having a minimum initial boiling point (IBP) of 490° C. and at least 10 wt % of ingredients in the boiling range of IBP to 550° C.;
b. subjecting the vacuum residue thus obtained to a de-asphalting process to obtain de-asphalted oil and asphalt;
c. separating the asphalt thus produced; and
d. subjecting the de-asphalted oil to aromatic extraction process to obtain the aromatic enriched deasphalted oil extract fraction comprising ingredients having a minimum initial boiling point (IBP) of 490° C.; at least 10 wt % of ingredients in the boiling range of IBP to 550° C.; and ingredients contributing to aromatic carbon in the range of 25 to 75 wt %; the aromatic enriched deasphalted oil extract fraction exhibiting an aniline point in the range of 55° to 70° C.; and comprises less than 10 ppm of poly cyclic aromatics (PCA) ingredients selected from the group consisting of benzo(a)anthracene+chrysene, benzo(j)floranthene, benzo(e)pyrene, benzo(b)floranthene, benzo(K)floranthene, benzo(a)pyrene and dibenzo(a,h)anthracene; with benzo(a)pyrene concentration of less than 1 ppm.

3. The process as claimed in claim 2, wherein the reduced crude oil is selected from a group comprising of Arab mix, Basrah Light, and Kuwait and the reduced crude oil has the following characteristics:

| | |
|---|---|
| Density | 0.9489 |
| Distillation data (D1160) ° C. | |
| IBP | 277 |
| 5 vol % | 325 |
| 10 vol % | 349 |
| 20 vol % | 389 |
| 30 vol % | 432 |
| 40 vol % | 478 |
| 50 vol % | 521 |
| 60 vol % | 561 |

4. The process as claimed in claim 2, wherein subjecting the reduced crude oil to distillation comprises performing a distillation process in accordance with any of ASTM standard procedure number D1160 or D5236.

5. The process as claimed in claim 2, wherein subjecting the vacuum residue thus obtained to a de-asphalting process comprises a solvent based deasphalting process comprising the step of contacting the vacuum residue with C3-C6 alkanes and its isomers and mixture and particularly with a source of propane in a column reactor having top and bottom temperatures of about 65° C. and about 55° C., respectively to obtain de-asphalted oil (DAO) and asphalt, wherein about eight parts by volume of propane is contacted with one part by volume of the vacuum reside.

6. The process as claimed in claim 2, wherein subjecting the deasphalted oil to extraction process comprises:
a. contacting the deasphalted oil with a solvent system and producing an extract phase and a raffinate product phase; and
b. separating the extract phase from the raffinate product phase;
wherein:
c. the solvent system comprises a primary solvent and a co-solvent capable of facilitating phase separation, wherein the primary solvent comprises N-methyl pyrolidone or furfural and the co-solvent comprises one or more aliphatic amides having carbon chain of less than 5 carbon atoms, wherein the co-solvent is preferably selected from formamide, n-methyl formamide and n-n dimethyl formamide and wherein a ratio of primary solvent to the co-solvent is in the range of 70:30 to 95:5.

7. A bitumen, comprising primary asphalt and 1 to 40 wt % of aromatic enriched deasphalted oil extract fraction, wherein the aromatic enriched deasphalted oil extract fraction comprises ingredients having a minimum initial boiling point (IBP) of 490° C.; at least 10 wt % of ingredients in the boiling range of IBP to 550° C.; poly cyclic aromatics (PCA) ingredients selected from the group consisting of benzo(a)anthracene+chrysene, benzo(j)floranthene, benzo(e)pyrene, benzo(b)floranthene, benzo(K)floranthene, benzo(a)pyrene and Dibenzo(a,h)anthracene being present at a concentration of less than 10 ppm; with benzo(a)pyrene concentration of less than 1 ppm; an aniline point in the range of 55° to 70° C. and ingredients contributing to aromatic carbon in the range of 25 to 75 wt %.

8. The bitumen as claimed in claim 7, wherein the bitumen is Viscosity Grade-10 (VG10) grade bitumen comprising 20 to 40 wt % of aromatic enriched deasphalted oil extract fraction and having a minimum kinematic viscosity of 250 cSt at 135° C., a minimum absolute viscosity of 800 poise at 60° C., a penetration point ranging from 80 to 100 ( 1/10 mm) at 25° C. and a minimum softening point of 40° C.

9. The bitumen as claimed in claim 7, wherein the bitumen is Viscosity Grade-20 (VG20) grade bitumen comprising 15 to 35 wt % of aromatic enriched deasphalted oil extract fraction and having a minimum kinematic viscosity of 300 cSt at 135° C., a minimum absolute viscosity of 1600 poise at 60° C., a penetration point ranging from 60 to 80 ( 1/10 mm) at 25° C. and a minimum softening point of 45° C.

10. The bitumen as claimed in claim 7, wherein the bitumen is Viscosity Grade-30 (VG30) grade bitumen comprising 10 to 30 wt % of aromatic enriched deasphalted oil extract fraction and having a minimum kinematic viscosity of 350 cSt at 135 ° C., a minimum absolute viscosity of 2400 poise at 60° C., a penetration point range from 50 to 70 ( 1/10 mm) at 25° C. and a minimum softening point of 47° C.

11. The bitumen as claimed in claim 7, wherein the bitumen is Viscosity Grade-40 (VG40) grade bitumen comprising 5 to 25 wt % of aromatic enriched deasphalted oil extract fraction and having a minimum kinematic viscosity of 400 cSt at 135° C., a minimum absolute viscosity of 3200 poise at 60° C., a penetration point range from 40 to 60 ( 1/10 mm) at 25° C. and a minimum softening point of 50° C.

12. A process for preparing bitumen, comprising:
a. subjecting a reduced crude oil to a distillation process to obtain vacuum residue comprising ingredients having a minimum initial boiling point (IBP) of 490° C. and at least 10 wt % of ingredients in the boiling range of IBP to 550° C.;
b. subjecting the vacuum residue thus obtained to a de-asphalting process to obtain de-asphalted oil and asphalt;
c. separating the asphalt thus produced;
d. subjecting the de-asphalted oil to aromatic extraction process to obtain an aromatic enriched deasphalted oil extract fraction comprising ingredients having a minimum initial boiling point (IBP) of 490° C.; at least 10 wt % of ingredients in the boiling range of IBP to 550° C.; poly cyclic aromatics (PCA) ingredients selected from the group consisting of benzo(a)anthracene+chrysene, benzo(j)floranthene, benzo(e)pyrene, benzo(b)floranthene, benzo(K)floranthene, benzo(a)pyrene and Dibenzo(a,h)anthracene being present at a concentration of less than 10 ppm; with benzo(a)pyrene concentration of less than 1 ppm; an aniline point in the range of 55° to 70° C. and ingredients contributing to aromatic carbon in the range of 25 to 75 wt %; and
e. mixing asphalt with 1 to 40 wt % of the aromatic enriched deasphalted oil extract fraction thus obtained in step (d).

13. The process as claimed in claim 12, wherein the reduced crude oil is selected from a group comprising of Arab mix, Basrah Light, and Kuwait and the reduced crude oil has the following characteristics:

| | |
|---|---|
| Density | 0.9489 |
| Distillation data (D1160) ° C. | |
| IBP | 277 |
| 5 vol % | 325 |
| 10 vol % | 349 |
| 20 vol % | 389 |
| 30 vol % | 432 |
| 40 vol % | 478 |
| 50 vol % | 521 |
| 60 vol % | 561 |

14. The process as claimed in claim 12, wherein subjecting the reduced crude oil to distillation comprises performing a distillation process in accordance with any of ASTM standard procedure number D1160 or D5236.

15. The process as claimed in claim 12, wherein subjecting the vacuum residue thus obtained to a de-asphalting process comprises a solvent based deasphalting process comprising the step of contacting the vacuum reside with C3-C6 alkanes and its isomers and mixture and particularly with a source of propane in a column reactor having top and bottom temperatures of about 65° C. and about 55° C., respectively to obtain de-asphalted oil (DAO) and asphalt, wherein about eight parts by volume of propane is contacted with one part by volume of the vacuum reside.

16. The process as claimed in claim 12, wherein subjecting the deasphalted oil to extraction process comprises:
a. contacting the deasphalted oil with a solvent system and producing an extract phase and a raffinate product phase; and
b. separating the extract phase from the raffinate product phase;
wherein:
c. the solvent system comprises a primary solvent and a co-solvent capable of facilitating phase separation, wherein the primary solvent comprises N-methyl pyrolidone or furfural and the co-solvent comprises one or more aliphatic amides having carbon chain of less than 5 carbon atoms, wherein the co-solvent is preferably selected from formamide, n-methyl formamide and n-n dimethyl formamide and wherein a ratio of primary solvent to the co-solvent is in the range of 70:30 to 95:5.
